(19) United States
(12) Patent Application Publication
(10) Pub. No.: US 2012/0217893 A1
(43) Pub. Date: Aug. 30, 2012

(54) INVERTER DEVICE, ILLUMINATION DEVICE FOR DISPLAY DEVICE PROVIDED WITH THE SAME, AND DISPLAY DEVICE

(75) Inventor: Shinji Matsumoto, Osaka-Shi (JP)

(73) Assignee: Sharp Kabushiki Kaisha, Osaka-Shi, Osaka (JP)

(21) Appl. No.: 13/505,756

(22) PCT Filed: Oct. 1, 2010
(86) PCT No.: PCT/JP2010/067206

§ 371 Date: May 3, 2012

(30) Foreign Application Priority Data
Dec. 15, 2009 (JP) 2009-284107

(51) Int. Cl. H05B 41/24

(52) U.S. Cl. 315/255

(57) ABSTRACT

Disclosed is an inverter device which is provided with a plurality of transformers and which drives a plurality of discharge tube lamps using the output voltage of the plurality of transformers as applied voltages that are respectively applied to the plurality of discharge tube lamps, wherein at least one axial direction of secondary windings of the plurality of transformers is set in a direction that is different from the other axial directions.

### TECHNICAL FIELD

The present invention relates to an inverter device for driving a plurality of discharge tube lamps; an illumination device for a display device that includes the inverter device; and a display device.

### BACKGROUND ART

An inverter device used in an illumination device for a display device applies a high-frequency high voltage to each of a plurality of discharge tube lamps, thereby driving the plurality of discharge tube lamps. In this way, the plurality of discharge tube lamps are turned on, whereby the illumination device for a display device functions as an illumination device.

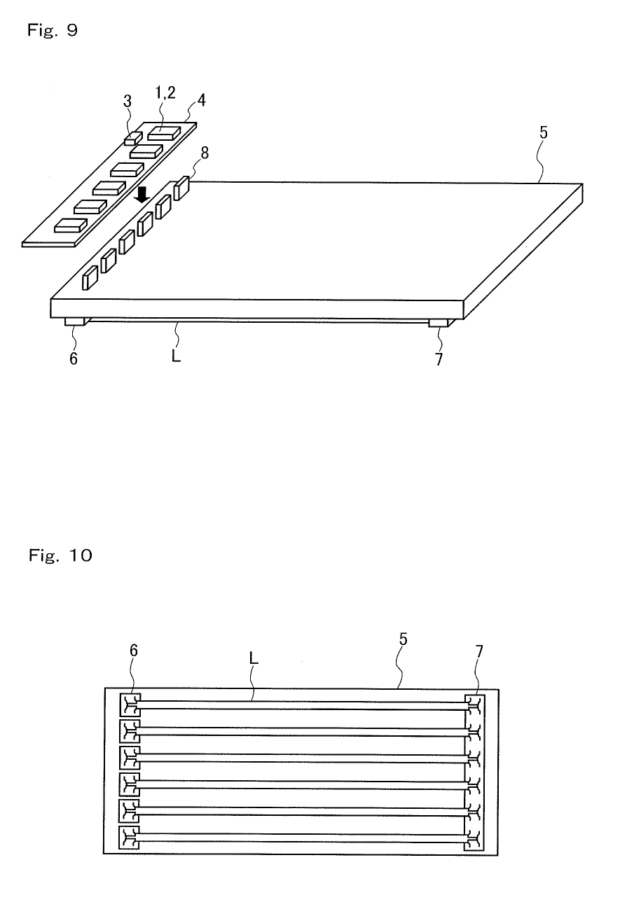

FIG. 9 shows a rear-side perspective view of an illumination device for a display device that includes a conventional inverter device and FIG. 10 shows a front view.

The illumination device for a display device shown in FIG. 9 and FIG. 10 includes: six discharge tube lamps (e.g., cold-cathode tube lamps) L; the conventional inverter device for driving the six discharge tube lamps L; an inverter board 4; and a chassis 5.

The conventional inverter device is composed of: six DC/AC conversion portions 1; six voltage step-up portions 2; and a control portion 3 that controls the six DC/AC conversion portions 1, and the inverter device is mounted on the inverter board 4. Each DC/AC conversion portions 1 converts a d.c. input voltage into a high-frequency (e.g., several tens of kilohertz) a.c. voltage. Besides, the voltage step-up portion 2 includes a voltage step-up transformer, and each voltage step-up portion 2 steps up an output voltage from each DC/AC conversion portion 1 by means of each transformer and applies the voltage to each discharge tube lamp L. In other words, the output voltage from the transformer of each voltage step-up portion 2 is used as each application voltage applied to each discharge tube lamp L.

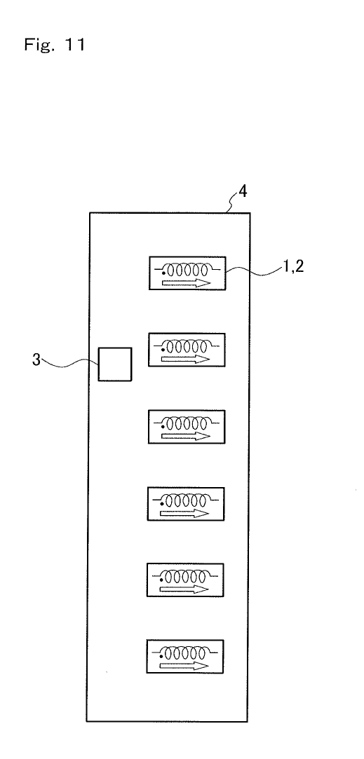

In the conventional inverter device, as shown in FIG. 11, axial directions of secondary windings of the respective transformers of the voltage step-up portions 2 are aligned with one another, and each voltage step-up portion 2 and each DC/AC conversion portion 1 arranged with each voltage step-up portion 2 into a unit are disposed. Here, FIG. 11 is a view showing a mount surface of the inverter board 4 on which the conventional inverter device is mounted. Besides, the winding in FIG. 11 schematically shows the secondary winding of the transformer of the voltage step-up portion 2; a black dot in FIG. 11 shows a hot side of the secondary winding of the transformer of the voltage step-up portion 2; and a white arrow in FIG. 11 shows the axial direction of the secondary winding of the transformer of the voltage step-up portion 2.

One end of each discharge tube lamp L is held by a first holder 6 that is disposed on a front surface of the chassis 5, while the other end of each discharge tube lamp L is held by a second holder 7 that is disposed on the front surface of the chassis 5. Besides, on a rear surface of the chassis 5, six connectors 8 are disposed at positions that correspond to the first holders 6. Respective one-end terminals of the discharge tube lamps L are each electrically connected to connector terminals of the respective connectors 8 via respective electro-conductive first holders 6, while the other-end terminals of the respective discharge tube lamps L are electrically connected to a ground potential in common via the electro-conductive second holders 7.

In the inverter board 4, on a surface opposite to the mount surface of the inverter device, inverter-side connectors (not shown) paired with the connectors 8 are disposed. One output terminal of each voltage step-up portion 2 is electrically connected to a connector terminal of each inverter-side connector, while the other output terminal of each voltage step-up portion 2 is electrically connected to the ground potential.

When the inverter board 4 is mounted onto the rear surface of the chassis 5 in a black arrow direction in FIG. 9, each connector 8 of the chassis 5 is connected to each inverter-side connector (not shown) of the inverter board 4. When the connection is completed, it becomes possible to drive the plurality of discharge tube lamps L by means of the conventional inverter device.

### CITATION LIST

### Patent Literature

PLT1: JP-A-1996-236288

### SUMMARY OF INVENTION

### Technical Problem

When a current flows into the transformer of each voltage step-up portion 2, an electromagnetic wave occurs in a direction perpendicular to a traveling direction of a current in the secondary winding of the transformer of each voltage step-up portion 2, and this electromagnetic wave is radiated into the air to become an unnecessary radiation.

In the conventional inverter device, as described above, the axial directions of the secondary windings of the respective transformers of the voltage step-up portions 2 are aligned with one another; accordingly, also the directions of the electromagnetic waves (unnecessary radiations) occurring from the respective transformers of the voltage step-up portions 2 are aligned with one another; as a result of this, there is a problem that because of a synergy effect of the electromagnetic waves (unnecessary radiations) in the same direction, the level of the unnecessary radiation becomes high.

Here, a patent document 1 discloses an invention relating to disposition of a transformer, more specifically, an invention of a backlight device in which an a.c. high-voltage generation portion, which uses a piezo-electric transformer near a high-voltage terminal of a discharge tube lamp, is disposed. The patent document 1 is not an invention that relates to disposition of a plurality of transformers but an invention that relates to disposition of a single transformer; in addition, the transformer is not an electromagnetic transformer (transformer that has a primary winding and a secondary winding) but a piezo-electric transformer; accordingly, the above problems are not solved.

In light of the above circumstance, it is an object of the present invention to provide an inverter device that is able to reduce unnecessary radiation, an illumination device for a display device that includes the inverter device, and a display device.

### Solution to Problem

To achieve the above object, an inverter device according to the present invention is an inverter device that includes a plurality of transformers and uses each of output voltages from the plurality of transformers as each application voltage applied to each of a plurality of discharge tube lamps, thereby driving the plurality of discharge tube lamps; wherein of axial directions of respective secondary windings of the plurality of transformers, at least one is a direction different from the other directions.

Here, a structure, in which a filter circuit and the like are disposed between the transformers and the discharge tube lamps and respective output voltages from the plurality of transformers are each applied to each of the plurality of discharge tube lamps via the filter circuits and the like, is also covered by the above structure “an inverter device that uses each of output voltages from the plurality of transformers as each application voltage applied to each of a plurality of discharge tube lamps, thereby driving the plurality of discharge tube lamps.”

Besides, from a viewpoint of enlarging a difference degree in directions of electromagnetic waves (unnecessary radiations) generated from the plurality of transformers, the axial directions of the respective secondary windings of the plurality of transformers may be directions different from one another.

Besides, to achieve the above object, an illumination device for a display device according to the present invention includes: the inverter device that has any one of the above structures; and a plurality of discharge tube lamps that are driven by the inverter device.

Besides, to achieve the above object, a display device according to the present invention includes the illumination device for a display device that has the above structure.

Besides, the display device may be a television receiving device.

### ADVANTAGEOUS EFFECTS OF INVENTION

According to the present invention, directions of the electromagnetic waves (unnecessary radiations) generated from the plurality of transformers of the inverter device become unequal, levels of the electromagnetic waves (unnecessary radiations) in one direction are dispersed; as a result of this, a synergy effect between the electromagnetic waves (unnecessary radiations) in the same direction becomes weak and the levels of the unnecessary radiations become small.

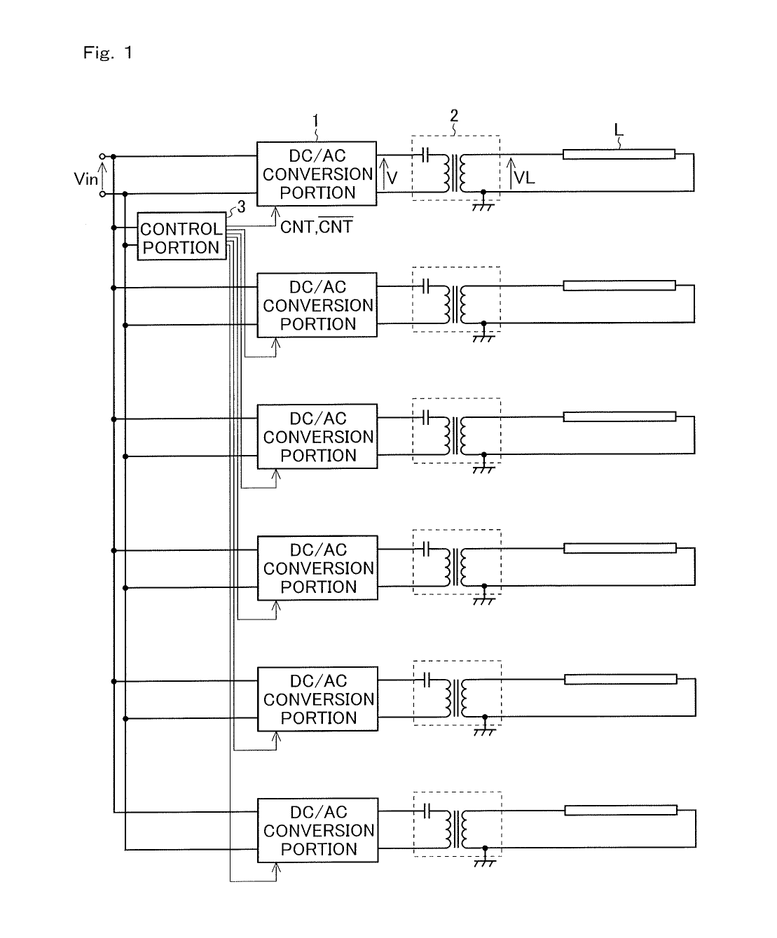

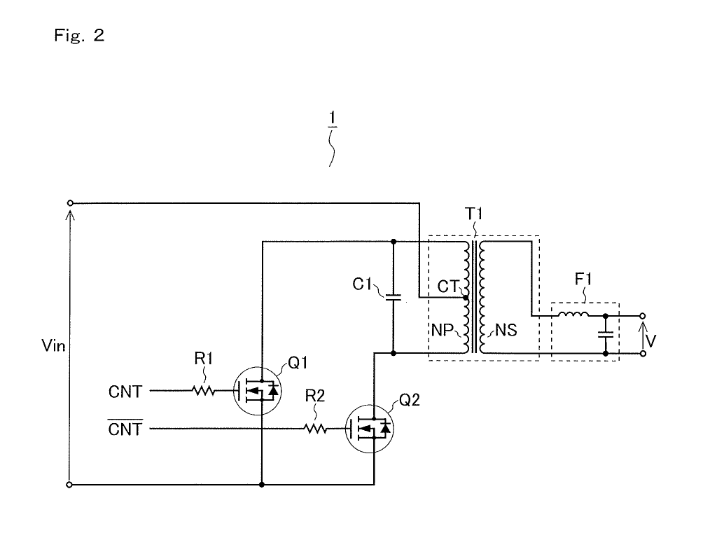

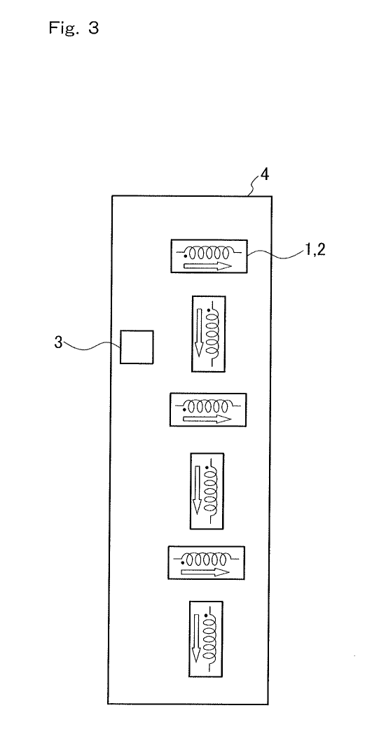

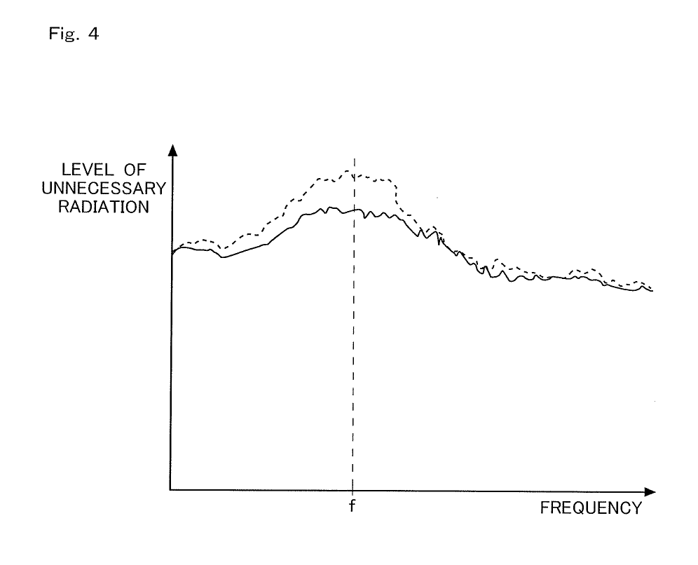

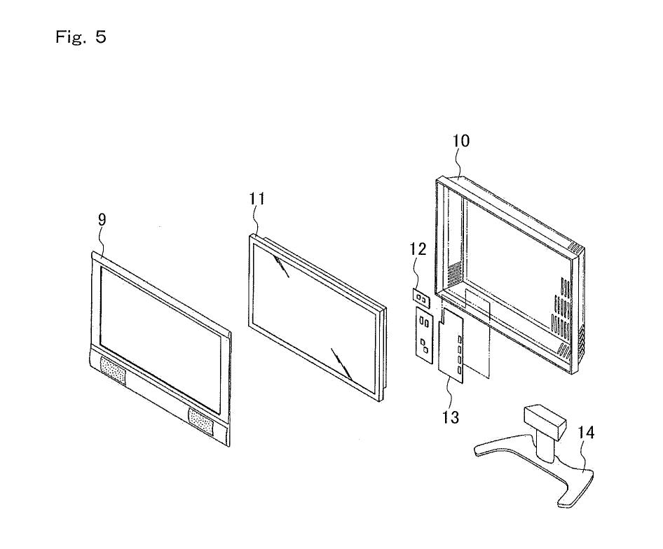

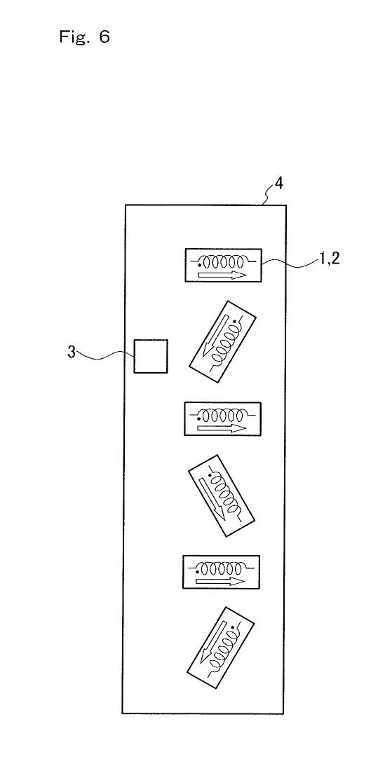

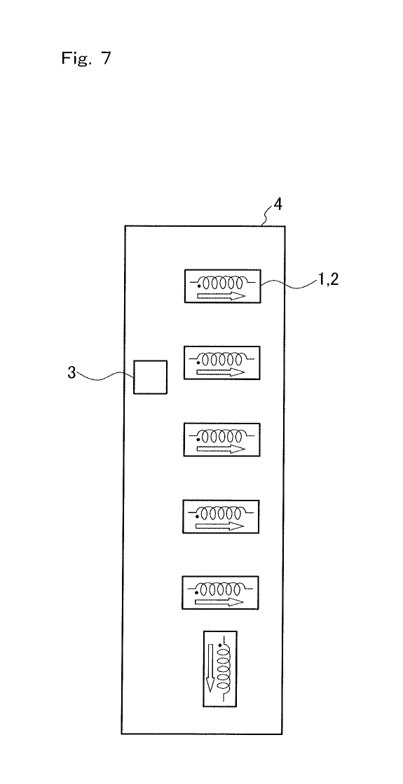

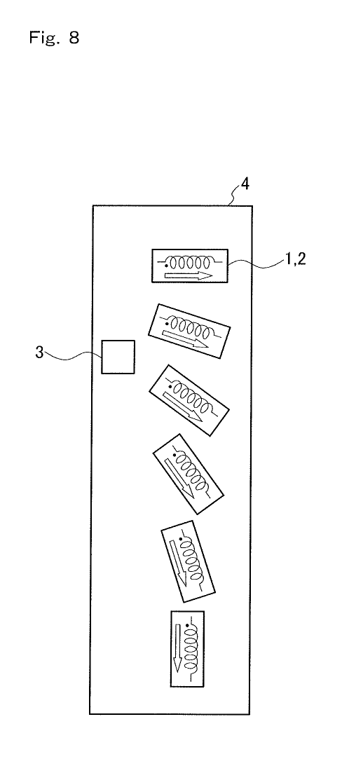

### BRIEF DESCRIPTION OF DRAWINGS

[FIG. 1] is a view showing an electric structure of an inverter device according to an embodiment of the present invention.

[FIG. 2] is a view showing a structural example of a DC/AC conversion portion.

[FIG. 3] is a view showing a mount surface of an inverter board on which an inverter device according to an embodiment of the present invention is mounted.

[FIG. 4] is a view showing an unnecessary radiation from an inverter device according to an embodiment of the present invention and an unnecessary radiation from a conventional inverter device.

[FIG. 5] is an exploded perspective view of a liquid crystal television receiving device that is an example of a display device according to the present invention.

[FIG. 6] is a view showing a mount surface of an inverter board on which an inverter device according to the present invention is mounted.

[FIG. 7] is a view showing a mount surface of an inverter board on which an inverter device according to the present invention is mounted.

[FIG. 8] is a view showing a mount surface of an inverter board on which an inverter device according to the present invention is mounted.

[FIG. 9] is a rear-side perspective view of an illumination device for a display device that includes a conventional inverter device.

[FIG. 10] is a front view of an illumination device for a display device that includes a conventional inverter device.

[FIG. 11] is a view showing a mount surface of an inverter board on which a conventional inverter device is mounted.

### DESCRIPTION OF EMBODIMENTS

Embodiments of the present invention are described hereinafter with reference to the drawings. Here, in the drawings that are referred to when describing the embodiments of the present invention, the same portions as in FIG. 9 to FIG. 11 are indicated by the same reference numbers.

<Illumination Device for a Display Device Including an Inverter Device According to an Embodiment of the Present Invention>

An illumination device for a display device including an inverter device according to an embodiment of the present invention has the same structure as the illumination device (illumination device for a display device shown in FIG. 9 and FIG. 10) for a display device that includes the conventional inverter device except for the disposition of each voltage step-up portion 2 and the disposition of each DC/AC conversion portion 1 arranged together with each voltage step-up portion 2 in the unit. Because of this, a rear-side perspective view and a front view of the illumination device for a display device including the inverter device according to the embodiment of the present invention are skipped.

The inverter device according to the embodiment of the present invention, as shown in FIG. 1, includes each DC/AC conversion portion 1 that converts a d.c. input voltage Vin into a high-frequency (e.g, several tens of kilohertz) a.c. voltage; each voltage step-up portion 2 that steps up respective output voltages from the DC/AC conversion portions 1 and applies the voltages to respective discharge tube lamps L; and a control portion 3 that control each DC/AC conversion portion 1.

Here, a structural example of the DC/AC conversion portion 1 is shown in FIG. 2. In the structural example in FIG. 2, the DC/AC conversion portion 1 is a push-pull DC/AC conversion circuit, which includes: switching elements Q1 and Q2; resistors R1 and R2; a capacitor C1; a transformer T1; a and a low-pass filter circuit F1.

The switching elements Q1 and Q2 are each composed of an N channel enhancement type MOS transistor and a feedback diode connected in reverse parallel with the transistor. A PWM (Pulse Width Modulation) control signal CNT output from the control portion 3 (see FIG. 1) is supplied to a gate of the switching element Q1 via the resistor R1, while a reverse PWM control signal CNT output from the control portion 3 is supplied to a gate of the switching element Q2 via the resistor R2. The reverse PWM control signal C N̅T is a reverse signal of the PWM control signal CNT; accordingly, the switching elements Q1 and Q2 are alternately changed in states of an on state and an off state in a complementary manner.

The transformer T1 has a primary winding NP and a secondary winding NS, and the primary winding NP is provided with a center tap CT. A drain of the switching element Q1 and one end of the capacitor C1 are connected to one end of the primary winding NP; a drain of the switching element Q2 and the other end of the capacitor C2 are connected to the other end of the primary winding NP; and a source of the switching element Q1 and a source of the switching element Q2 are connected to a common connection point. And, the d.c. input voltage Vin is applied across the common connection point and the center tap CT.

The switching elements Q1 and Q2 are alternately changed in the states of the on state and the off state in a complementary manner, whereby a current alternately flows in a connection line between the drain of the switching element Q1 and the one end of the primary winding NP and a connection line between the source of the switching element Q1 and the source of the switching element Q2, so that a direction of the current flowing in the primary winding NP changes; as a result of this, a rectangular-waveform voltage is generated across both ends of the secondary winding NS. This rectangular-waveform voltage generated across both ends of the secondary winding NS is shaped into a sine-wave voltage V by the low-pass filter circuit F1. Here, a leakage inductor of the transformer T1 may be used as an inductor that is a constituent element of the low-pass filter circuit F1.

The sine-wave voltage V output from the DC/AC conversion portion 1 is stepped up to a sine-wave high voltage VL by the voltage step-up portion 2 (see FIG. 1) and the sine-wave high voltage VL is applied across both ends of the discharge tube lamp L (see FIG. 1).

The control portion 3 controls each DC/AC conversion portion 1 by means of the PWM control signal CNT and the reverse PWM control signal C N̅T in such a way that for example, the respective output voltages V from the DC/AC conversion portions have the same frequency and the same phase.

Next, differences between the illumination device for a display device that includes the inverter device according to the embodiment of the present invention and the illumination device (illumination device for a display device shown in FIG. 9 and FIG. 10) for a display device that includes the conventional inverter device are described with reference to FIG. 3.

FIG. 3 is a view showing a mount surface of the inverter board 4 on which the inverter device according to the embodiment of the present invention is mounted. Here, a winding in FIG. 3 schematically shows the secondary winding of the transformer of the voltage step-up portion 2; a black dot in FIG. 3 shows a hot side of the secondary winding of the transformer of the voltage step-up portion 2; and a white arrow in FIG. 3 shows the axial direction of the secondary winding of the transformer of the voltage step-up portion 2.

In the inverter device according to the embodiment of the present invention, as shown in FIG. 3, each voltage step-up portion 2 and each DC/AC conversion portion 1 arranged together with each voltage step-up portion 2 into a unit are disposed in such a way that the axial directions of the secondary windings of the respective transformers of the voltage step-up portions 2 form an angle of 90° between neighboring transformers. In other words, in the inverter device according to the embodiment of the present invention, the axial directions of the secondary windings of the respective transformers of the voltage step-up portions 2 are different. As a result of this, in the inverter device according to the embodiment of the present invention, regarding electromagnetic waves (unnecessary radiations) generated from the respective transformers of the voltage step-up portions 2, levels of the electromagnetic waves (unnecessary radiations) in one direction are dispersed; a synergy effect between the electromagnetic waves (unnecessary radiations) in the same direction becomes weak and the levels of the unnecessary radiations become small.

Here, FIG. 4 shows a comparison result between the unnecessary radiation from the inverter device according to the embodiment of the present invention and the unnecessary radiation from the conventional inverter device (see FIG. 11). In FIG. 4, a solid line shows the unnecessary radiation from the inverter device according to the embodiment of the present invention and a dotted line shows the unnecessary radiation from the above conventional inverter device.

In the inverter device according to the embodiment of the present invention, as being clear from FIG. 4, the unnecessary radiation is reduced compared with the above conventional inverter device. Here, a sign f in FIG. 4 is a drive frequency of the respective transformers of the voltage step-up portions 2.

<Display Device According to an Embodiment of the Present Invention>

A display device according to an embodiment of the present invention is structured so as to include the above illumination device for a display device according to the embodiment of the present invention and a display panel. As a specific display device according to the embodiment of the present invention, for example, there is a transmissive liquid crystal display device that uses the above illumination device for a display device according to the embodiment of the present invention as a backlight unit and is provided with a liquid crystal display panel on a front surface.

Here, FIG. 5 shows an example of an exploded perspective view in case where the display device according to the embodiment of the present invention is a liquid crystal television receiving device. A transmissive liquid crystal display portion 11, a tuner 12, and a power supply 13 are disposed between a front cabinet 9 and a rear cabinet 10, and the rear cabinet 10 is held by a stand 14. The transmissive liquid crystal display portion 11 uses the above illumination device for a display device according to the embodiment of the present invention as a backlight unit and is provided with a liquid crystal display panel on the front surface. Besides, the power supply 13 convers a commercial a.c. voltage into a d.c. voltage and supplies the d.c. voltage to portions such as the transmissive liquid crystal display portion 11, the tuner 12 and the like.

<Others>

Hereinbefore, the embodiments according to the present invention are described; however, the scope of the present invention is not limited to these, and it is possible to add various modifications and put them into practical applications without departing the spirit of the present invention. Hereinafter, some modifications are described.

For example, a filter circuit and the like may be disposed between each voltage step-up portion 2 of the inverter device according to the embodiment of the present invention and each discharge tube lamp L.

Besides, disposition distances between the respective transformers of the voltage step-up portions 2, that is, distances between neighboring transformers may be all equal to one another, part of them may be equal to one another, or all may be different from one another.

Besides, in the above embodiments, each voltage step-up portion 2 and each DC/AC conversion portion I arranged together with each voltage step-up portion 2 into the unit are disposed in such a way that the axial directions of the secondary windings of the respective transformers of the voltage step-up portions 2 form the angle of 90° between the neighboring transformers; however, the angle formed between the axial directions of the secondary windings of the neighboring transformers is not limited to 90° and may be larger than 0° and equal to or smaller than 90°. Accordingly, for example, a disposition shown in FIG. 6 may be used.

Besides, in the present invention, of the axial directions of the secondary windings of the respective transformers of the voltage step-up portions 2, at least one may be a direction different from the other directions; accordingly, for example, a disposition shown in FIG. 7 may be used. However, as shown in FIG. 8, when the axial directions of the secondary windings of the respective transformers of the voltage step-up portions 2 are different from one another, a difference degree among the axial directions of the secondary windings of the respective transformers of the voltage step-up portions 2 becomes larger, whereby it is possible to reduce the unnecessary radiation more. In FIG. 8, the angles formed between the axial directions of the secondary windings of the neighboring transformers are all set at 18°.

Here, the windings in FIG. 6 to FIG. 8 schematically show the secondary windings of the transformers of the voltage step-up portions 2. Black dots in FIG. 6 to FIG. 8 show hot sides of the secondary windings of the voltage step-up portions 2; and white arrows in FIG. 6 to FIG. 8 show the axial directions of the secondary windings of the transformers of the voltage step-up portions 2.

Besides, in the above embodiments, the axial directions of the secondary windings of the transformers of the voltage step-up portions 2 are adjusted by the disposition of each voltage step-up portion 2 and each DC/AC conversion portion 1 arranged together with each voltage step-up portion 2 in the unit; however, if only the axial directions of the secondary windings of the transformers of the voltage step-up portions 2 are adjustable, the effects of the present invention are obtainable; accordingly, the axial directions of the primary windings of the respective transformers of the voltage step-up portions 2 may be all identical to one another, part of them may be identical to one another, or all may be different from one another. Besides, if only the axial directions of the secondary windings of the transformers of the voltage step-up portions 2 are adjustable, the direction of each voltage step-up portion 2 and the direction of each DC/AC conversion portion 1 are not especially limited.

### INDUSTRIAL APPLICABILITY

The inverter device according to the present invention is usable to drive a plurality of discharge tube lamps.

### REFERENCE SIGNS LIST

1 DC/AC conversion portion
2 voltage step-up portion
3 control portion
4 inverter board
5 chassis
6 first holder
7 second holder
8 connector
9 front cabinet
10 rear cabinet
11 transmissive liquid crystal display portion
12 tuner
13 power supply
14 stand
C1 capacitor
CT center tap
F1 low-pass filter circuit
L discharge tube lamp
NP primary winding
NS secondary winding
Q1, Q2 switching elements
R1, R2 resistors
T1 transformer

1. An inverter device comprising a plurality of transformers and using each of output voltages from the plurality of transformers as each application voltage applied to each of a plurality of discharge tube lamps, the inverter device drives the plurality of discharge tube lamps; wherein
of axial directions of respective secondary windings of the plurality of transformers, at least one is a direction different from other directions.

2. The inverter device according to claim 1, wherein
the axial directions of the respective secondary windings of the plurality of transformers are directions different from one another.

3. An illumination device for a display device comprising:
the inverter device according to claim 1; and
a plurality of discharge tube lamps that are driven by the inverter device.

4. A display device comprising the illumination device for a display device according to claim 3.

5. The display device according claim 4, wherein
the display deice is a television receiving device.
